(19) United States
(12) Patent Application Publication
(10) Pub. No.: US 2024/0033910 A1
(43) Pub. Date: Feb. 1, 2024

(54) TRAINING DATA GENERATION DEVICE, MACHINE LEARNING DEVICE, AND ROBOT JOINT ANGLE ESTIMATION DEVICE

(71) Applicants: FANUC CORPORATION, Minamitsuru-gun, Yamanashi (JP); Hitachi, Ltd., Tokyo (JP)

(72) Inventors: Youhei NAKADA, Yamanashi (JP); Takeshi MOTODAKA, Tokyo (JP)

(21) Appl. No.: 18/267,293

(22) PCT Filed: Dec. 14, 2021
(86) PCT No.: PCT/JP2021/046117

§ 371 Date: Jun. 14, 2023

(30) Foreign Application Priority Data
Dec. 21, 2020 (JP) 2020-211712

(51) Int. Cl. B25J 9/16

(52) U.S. Cl. CPC B25J 9/163; B25J 9/1605

(57) ABSTRACT

A training data generation device generates training data for generating a trained model that takes a two-dimensional image of a robot captured by a camera as well as the distance and tilt between the camera and the robot as inputs, and that estimates angles of a plurality of joint shafts included in the robot when the two-dimensional image was captured and a two-dimensional posture indicating the locations of the centers of the plurality of joint shafts in the two-dimensional image. The training data generation device comprising: an input data acquisition unit for acquiring a two-dimensional image of the robot captured by the camera as well as the distance and tilt between the camera and the robot; and a label acquisition unit for acquiring, as label data, the two-dimensional posture and the angles of the plurality of joint shafts when the two-dimensional image was captured.

### TECHNICAL FIELD

The present invention relates to a training data generation device, a machine learning device, and a robot joint angle estimation device.

### BACKGROUND ART

As a method for setting a tool tip point of a robot, there is known a method of causing the robot to operate, instructing the robot to cause the tool tip point to touch a jig or the like in a plurality of postures, and calculating the tool tip point from angles of the joint axes in the postures. See, for example, Patent Document 1.
Patent Document 1: Japanese Unexamined Patent Application, Publication No. H8-085083

### DISCLOSURE OF THE INVENTION

### Problems to be Solved by the Invention

In order to acquire angles of the joint axes of a robot, it is necessary to implement a log function in a robot program or acquire data using a dedicated I/F of the robot.

In the case of a robot that is not implemented with a log function or a dedicated I/F, however, it is not possible to acquire angles of the joint axes of the robot.

Therefore, it is desired to, even for a robot that is not implemented with a log function or a dedicated I/F, easily acquire angles of the joint axes of the robot.

### Means for Solving the Problems

(1) An aspect of a training data generation device of the present disclosure is a training data generation device for generating training data for generating a trained model, the trained model receiving input of a two-dimensional image of a robot captured by a camera, and a distance and a tilt between the camera and the robot, and estimating angles of a plurality of joint axes included in the robot at a time when the two-dimensional image was captured, and a two-dimensional posture indicating positions of centers of the plurality of joint axes in the two-dimensional image, the training data generation device comprising: an input data acquisition unit configured to acquire the two-dimensional image of the robot captured by the camera, and the distance and tilt between the camera and the robot; and a label acquisition unit configured to acquire the angles of the plurality of joint axes at the time when the two-dimensional image was captured, and the two-dimensional posture as label data.
(2) An aspect of a machine learning device of the present disclosure comprising a learning unit configured to execute supervised learning based on training data generated by the training data generation device of (1) to generate a trained model.
(3) An aspect of a robot joint angle estimation device of the present disclosure comprising: a trained model generated by the machine learning device of (2); an input unit configured to input a two-dimensional image of a robot captured by a camera, and a distance and a tilt between the camera and the robot; and an estimation unit configured to input the two-dimensional image, and the distance and tilt between the camera and the robot, which have been inputted by the input unit, to the trained model, and estimate angles of a plurality of joint axes included in the robot at the time when the two-dimensional image was captured, and a two-dimensional posture indicating positions of centers of the plurality of joint axes in the two-dimensional image.

### Effects of the Invention

According to one aspect, it is possible to, even for a robot that is not implemented with a log function or a dedicated I/F, easily acquire angles of the joint axes of the robot.

### BRIEF DESCRIPTION OF THE DRAWINGS

FIG. 1 is a functional block diagram showing a functional configuration example of a system according to one embodiment on a learning phase;

FIG. 2A is a diagram showing an example of a frame image in which the angle of a joint axis J4 is 90 degrees;

FIG. 2B is a diagram showing an example of a frame image in which the angle of the joint axis J4 is −90 degrees;

FIG. 3 is a diagram showing an example for increasing the number of pieces of training data;

FIG. 4 is a diagram showing an example of coordinate values of joint axes on normalized XY coordinates;

FIG. 5 is a diagram showing an example of a relationship between a two-dimensional skeleton estimation model and a joint angle estimation model;

FIG. 6 is a diagram showing an example of feature maps of joint axes of a robot;

FIG. 7 is a diagram showing an example of comparison between a frame image and an output result of the two-dimensional skeleton estimation model;

FIG. 8 is a diagram showing an example of the joint angle estimation model;

FIG. 9 is a functional block diagram showing a functional configuration example of a system according to one embodiment on an operational phase;

FIG. 10 is a flowchart illustrating an estimation process of a terminal device on the operational phase; and

FIG. 11 is a diagram showing an example of a configuration of a system.

### PREFERRED MODE FOR CARRYING OUT THE INVENTION

One embodiment of the present disclosure will be described below using diagrams.

### One Embodiment

First, an outline of the present embodiment will be described.

In the present embodiment, on a learning phase, a terminal device such as a smartphone operates as a training data generation device (an annotation automation device) that receives input of a two-dimensional image of a robot captured by a camera included in the terminal device, and the distance and tilt between the camera and the robot, and generates training data for generating a trained model to estimate angles of a plurality of joint axes included in the robot at the time when the two-dimensional image was captured, and a two-dimensional posture indicating positions of the centers of the plurality of joint axes.

The terminal device provides the generated training data for a machine learning device, and the machine learning device executes supervised learning based on the provided training data to generate a trained model. The machine learning device provides the generated trained model for the terminal device.

On an operational phase, the terminal device operates as a robot joint angle estimation device that inputs the two-dimensional image of the robot captured by the camera, and the distance and tilt between the camera and the robot to the trained model to estimate the angles of the plurality of joint axes of the robot at the time when the two-dimensional image was captured, and the two-dimensional posture indicating the positions of the centers of the plurality of joint axes.

Thereby, according to the present embodiment, it is possible to solve the subject of “easily acquiring, even for a robot that is not implemented with a log function or a dedicated I/F, angles of the joint axes of the robot”.

The above is the outline of the present embodiment.

Next, a configuration of the present embodiment will be described in detail using drawings.

### <System on Learning Phase>

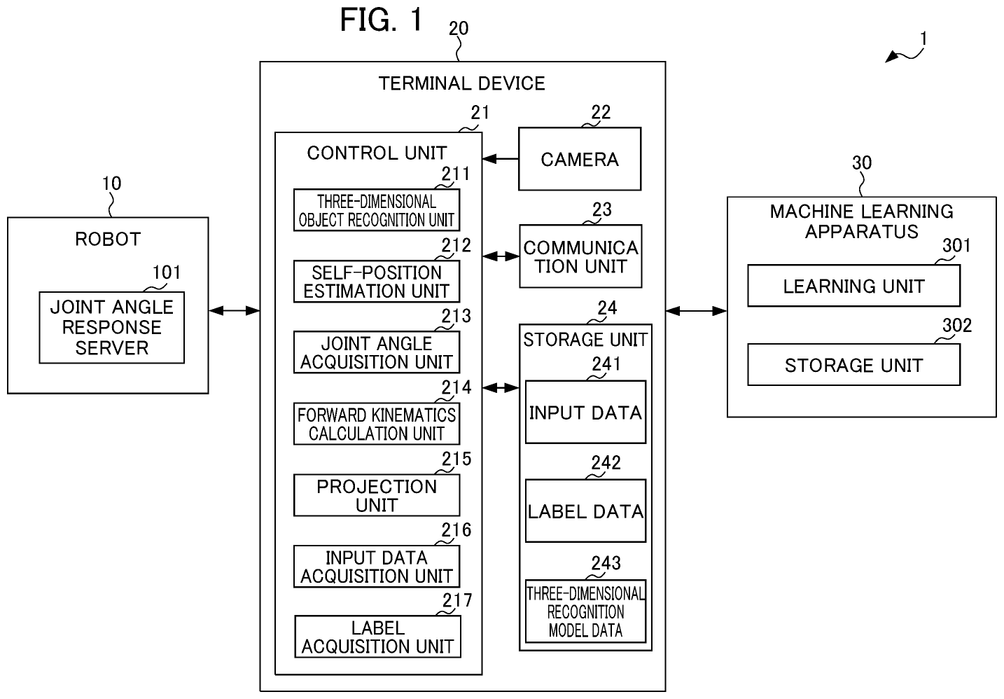

FIG. 1 is a functional block diagram showing a functional configuration example of a system according to one embodiment on the learning phase. As shown in FIG. 1, a system 1 includes a robot 10, a terminal device 20 as the training data generation device, and a machine learning device 30.

The robot 10, the terminal device 20, and the machine learning device 30 may be mutually connected via a network not shown such as a wireless LAN (local area network), Wi-Fi (registered trademark), and a mobile phone network conforming to a standard such as 4G or 5G. In this case, the robot 10, the terminal device 20, and the machine learning device 30 include communication units not shown for mutually performing communication via such connection. Though it has been described that the robot 10 and the terminal device 20 perform data transmission/reception via the communication units not shown, data transmission/reception may be performed via a robot control device (not shown) that controls motions of the robot 10.

The terminal device 20 may include the machine learning device 30 as described later. The terminal device 20 and the machine learning device 30 may be included in the robot control device (not shown).

In the description below, the terminal device 20 that operates as the training data generation device acquires, as the training data, only such pieces of data that are acquired at a timing when all the pieces of data can be synchronized. For example, if a camera included in the terminal device 20 captures frame images at 30 frames/s, and the period with which angles of a plurality of joint axes included in the robot 10 can be acquired is 100 milliseconds, and other data can be immediately acquired, then the terminal device 20 outputs training data as a file with the period of 100 milliseconds.

### <Robot 10>

The robot 10 is, for example, an industrial robot that is well known to one skilled in the art, and has a joint angle response server 101 incorporated therein. The robot 10 drives movable members (not shown) of the robot 10 by driving a servomotor not shown that is arranged for each of the plurality of joint axes not shown, which are included in the robot 10, based on a drive instruction from the robot control device (not shown).

Though the robot 10 will be described below as a 6-axis vertically articulated robot having six joint axes J1 to J6, the robot 10 may be a vertically articulated robot other than the six-axis one and may be a horizontally articulated robot, a parallel link robot, or the like.

The joint angle response server 101 is, for example, a computer or the like, and outputs joint angle data including angles of joint axes J1 to J6 of the robot 10 with the above-described predetermined period that enables synchronization, such as 100 milliseconds, based on a request from the terminal device 20 as the training data generation device described later. The joint angle response server 101 may output the joint angle data directly to the terminal device 20 as the training data generation device as described above, or may output the joint angle data to the terminal device 20 as the training data generation device via the robot control device (not shown).

The joint angle response server 101 may be an device independent of the robot 10.

### <Terminal Device 20>

The terminal device 20 is, for example, a smartphone, a tablet terminal, AR (augmented reality) glasses, MR (mixed reality) glasses, or the like.

As shown in FIG. 1, on an operational phase, the terminal device 20 includes a control unit 21, a camera 22, a communication unit 23, and a storage unit 24 as the training data generation device. The control unit 21 includes a three-dimensional object recognition unit 211, a self-position estimation unit 212, a joint angle acquisition unit 213, a forward kinematics calculation unit 214, a projection unit 215, an input data acquisition unit 216, and a label acquisition unit 217.

The camera 22 is, for example, a digital camera or the like, and photographs the robot 10 at a predetermined frame rate (for example, 30 frames/s) based on an operation by a worker, who is a user, and generates a frame image that is a two-dimensional image projected on a plane vertical to the optical axis of the camera 22. The camera 22 outputs the generated frame image to the control unit 21 described later with the above-described predetermined period that enables synchronization, such as 100 milliseconds. The frame image generated by the camera 22 may be a visible light image such as an RGB color image and a gray-scale image.

The communication unit 23 is a communication control device to perform data transmission/reception with a network such as a wireless LAN (local area network), Wi-Fi (registered trademark), and a mobile phone network conforming to a standard such as 4G or 5G. The communication unit 23 may directly communicate with the joint angle response server 101 or may communicate with the joint angle response server 101 via the robot control device (not shown) that controls motions of the robot 10.

The storage unit 24 is, for example, a ROM (read-only memory) or an HDD (hard disk drive) and stores a system program, a training data generation application program, and the like executed by the control unit 21 described later. Further, the storage unit 24 may store input data 241, label data 242, and three-dimensional recognition model data 243.

In the input data 241, input data acquired by the input data acquisition unit 216 described later is stored.

In the label data 242, label data acquired by the label acquisition unit 217 described later is stored.

In the three-dimensional recognition model data 243, feature values such as an edge quantity extracted from each of a plurality of frame images of the robot 10 are stored as a three-dimensional recognition model, the plurality of frame images having been captured by the camera 22 at various distances and with various angles (tilts) in advance by changing the posture and direction of the robot 10. Further, in the three-dimensional recognition model data 243, three-dimensional coordinate values of the origin of the robot coordinate system of the robot 10 (hereinafter also referred to as “the robot origin”) in a world coordinate system at the time when the frame image of each of the three-dimensional recognition models was captured, and information indicating a direction of each of the X, Y, and Z axes of the robot coordinate system in the world coordinate system may be stored in association with the three-dimensional recognition model.

When the terminal device 20 starts the training data generation application program, a world coordinate system is defined, and a position of the origin of the camera coordinate system of the terminal device 20 (the camera 22) is acquired as coordinate values in the world coordinate system. Then, when the terminal device 20 (the camera 22) moves after starting the training data generation application program, the origin in the camera coordinate system moves from the origin in the world coordinate system.

### <Control Unit 21>

The control unit 21 includes a CPU (central processing unit), a ROM, a RAM, a CMOS (complementary metal-oxide-semiconductor) memory and the like, and these are configured being mutually communicable via a bus and are well-known to one skilled in the art.

The CPU is a processor that performs overall control of the terminal device 20. The CPU reads out the system program and the training data generation application program stored in the ROM via the bus, and controls the whole terminal device 20 according to the system program and the training data generation application program. Thereby, as shown in FIG. 1, the control unit 21 is configured to realize the functions of the three-dimensional object recognition unit 211, the self-position estimation unit 212, the joint angle acquisition unit 213, the forward kinematics calculation unit 214, the projection unit 215, the input data acquisition unit 216, and the label acquisition unit 217. In the RAM, various kinds of data such as temporary calculation data and display data are stored. The CMOS memory is backed up by a battery not shown and is configured as a nonvolatile memory in which a storage state is kept even when the terminal device 20 is powered off.

### <Three-Dimensional Object Recognition Unit 211>

The three-dimensional object recognition unit 211 acquires a frame image of the robot 10 captured by the camera 22. The three-dimensional object recognition unit 211 extracts feature values such as an edge quantity from the frame image of the robot 10 captured by the camera 22, for example, using a well-known robot three-dimensional coordinate recognition method (for example, https://linx.jp/product/mvtec/halcon/feature/3d_vision.html). The three-dimensional object recognition unit 211 performs matching between the extracted feature values and the feature values of the three-dimensional recognition models stored in the three-dimensional recognition model data 243. Based on a result of the matching, the three-dimensional object recognition unit 211 acquires, for example, three-dimensional coordinate values of the robot origin in the world coordinate system and information indicating the direction of each of the X, Y, and Z axes of the robot coordinate system in a three-dimensional recognition model with the highest matching degree.

Though the three-dimensional object recognition unit 211 acquires the three-dimensional coordinate values of the robot origin in the world coordinate system, and the information indicating the direction of each of the X, Y, and Z axes of the robot coordinate system, using the robot three-dimensional coordinate recognition method, the present invention is not limited thereto. For example, by attaching a marker, such as a checker board, to the robot 10, the three-dimensional object recognition unit 211 may acquire the three-dimensional coordinate values of the robot origin in the world coordinate system and the information indicating the direction of each of the X, Y, and Z axes of the robot coordinate system, from an image of the marker captured by the camera 22 based on a well-known marker recognition technology.

Or alternatively, by attaching an indoor positioning device, such as a UWB (Ultra Wide Band), to the robot 10, and the three-dimensional object recognition unit 211 may acquire the three-dimensional coordinate values of the robot origin in the world coordinate system and the information indicating directions of each of the X, Y, and Z axes of the robot coordinate system, from the indoor positioning device.

### <Self-Position Estimation Unit 212>

The self-position estimation unit 212 acquires three-dimensional coordinate values of the origin of the camera coordinate system of the camera 22 in the world coordinate system (hereinafter also referred to as “the three-dimensional coordinate values of the camera 22”, using a well-known self-position estimation method. The self-position estimation unit 212 may be adapted to, based on the acquired three-dimensional coordinate values of the camera 22 and the three-dimensional coordinates acquired by the three-dimensional object recognition unit 211, calculate the distance and tilt between the camera 22 and the robot 10.

### <Joint Angle Acquisition Unit 213>

The joint angle acquisition unit 213 transmits a request to the joint angle response server 101 with the above-described predetermined period that enables synchronization, such as 100 milliseconds, for example, via the communication unit 23 to acquire angles of the joint axes J1 to J6 of the robot 10 at the time when a frame image was captured.

### <Forward Kinematics Calculation Unit 214>

The forward kinematics calculation unit 214 solves forward kinematics from the angles of the joint axes J1 to J6 acquired by the joint angle acquisition unit 213, for example, using a DH (Denavit-Hartenberg) parameter table defined in advance, to calculate three-dimensional coordinate values of positions of the centers of the joint axes J1 to J6 and calculate a three-dimensional posture of the robot 10 in the world coordinate system. The DH parameter table is created in advance, for example, based on the specifications of the robot 10 and is stored into the storage unit 24.

### <Projection Unit 215>

The projection unit 215 arranges the positions of the centers of the joint axes J1 to J6 of the robot 10 calculated by the forward kinematics calculation unit 214 in the three-dimensional space of the world coordinate system, for example, using a well-known method for projection to a two-dimensional plane, and generates two-dimensional coordinates (pixel coordinates) (xᵢ, yᵢ) of the positions of the centers of the joint axes J1 to J6 as a two-dimensional posture of the robot 10, by projecting, from the point of view of the camera 22 decided by the distance and tilt between the camera 22 and the robot 10 calculated by the self-position estimation unit 212, onto a projection plane decided by the distance and tilt between the camera 22 and the robot 10. Here, i is an integer from 1 to 6.

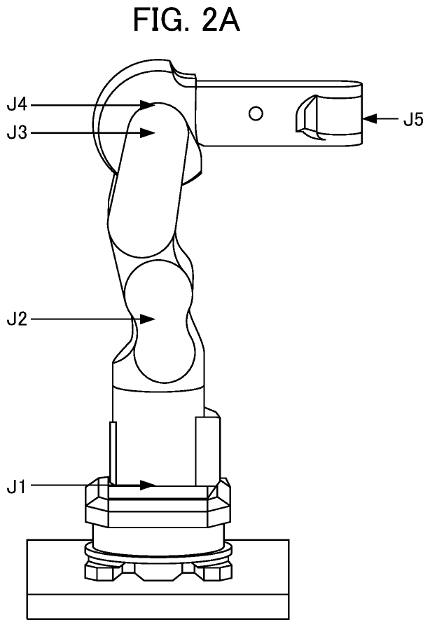

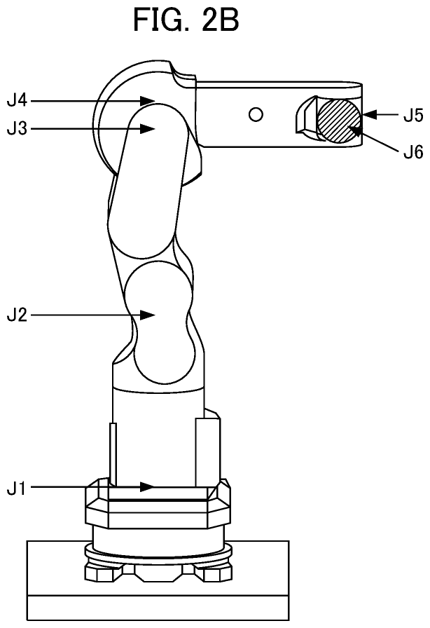

As shown in FIGS. 2A and 2B, there may be a case where a joint axis is hidden in a frame image, depending on a posture of the robot 10 and a photographing direction.

FIG. 2A is a diagram showing an example of a frame image in which the angle of the joint axis J4 is 90 degrees. FIG. 2B is a diagram showing an example of a frame image in which the angle of the joint axis J4 is −90 degrees.

In the frame image of FIG. 2A, the joint axis J6 is hidden and not seen. In the frame image of FIG. 2B, the joint axis J6 is seen.

Therefore, the projection unit 215 connects adjacent joint axes of the robot 10 with a line segment, and defines a thickness for each line segment with a link width of the robot 10 set in advance. The projection unit 215 judges whether there is another joint axis on each line segment or not, based on a three-dimensional posture of the robot 10 calculated by the forward kinematics calculation unit 214 and an optical axis direction of the camera 22 decided by the distance and tilt between the camera 22 and the robot 10. In a case like FIG. 2A where that another joint axis Ji exists on a side opposite to the camera 22 side in the depth direction, relative to a line segment, the projection unit 215 sets the confidence degree cᵢ of that other joint axis Ji (the joint axis J6 in FIG. 2A) to “0”. In a case like FIG. 2B where that other joint axis Ji exists on the camera 22 side relative to the line segment, the projection unit 215 sets the confidence degree cᵢ of that other joint axis Ji (the joint axis J6 in FIG. 2B) to “1”.

That is, the projection unit 215 may include, for the two-dimensional coordinates (pixel coordinates) (xᵢ, yᵢ) of the projected positions of the centers of the joint axes J1 to J6, the confidence degrees cᵢ indicating whether the joint axes J1 to J6 are shown or not, respectively, in a frame image, into the two-dimensional posture of the robot 10.

As for training data for performing supervised learning in the machine learning device 30 described later, it is desirable that many pieces of training data are prepared.

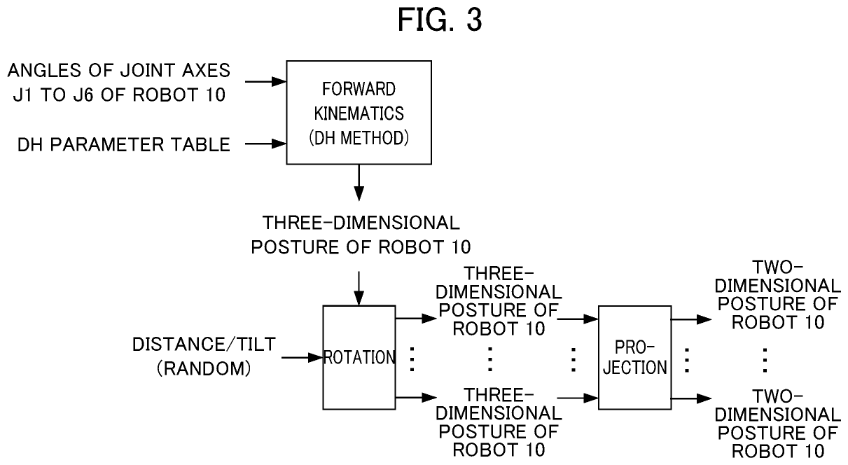

FIG. 3 is a diagram showing an example for increasing the number of pieces of training data.

As shown in FIG. 3, for example, in order to increase the number of pieces of training data, the projection unit 215 randomly gives a distance and a tilt between the camera 22 and the robot 10 to cause a three-dimensional posture of the robot 10 calculated by the forward kinematics calculation unit 214 to rotate. The projection unit 215 may generate many two-dimensional postures of the robot 10, by projecting the rotated three-dimensional posture of the robot 10 to a two-dimensional plane decided by the randomly given distance and tilt.

### <Input Data Acquisition Unit 216>

The input data acquisition unit 216 acquires a frame image of the robot 10 captured by the camera 22, and the distance and tilt between the camera 22 that has captured the frame image and the robot 10 as input data.

Specifically, the input data acquisition unit 216 acquires a frame image as input data, for example, from the camera 22. Further, the input data acquisition unit 216 acquires the distance and tilt between the camera 22 and the robot 10 at the time when the acquired frame image was captured, from the self-position estimation unit 212. The input data acquisition unit 216 acquires the frame image, and the distance and tilt between the camera 22 and the robot 10, which have been acquired, as input data, and stores the acquired input data into the input data 241 of the storage unit 24.

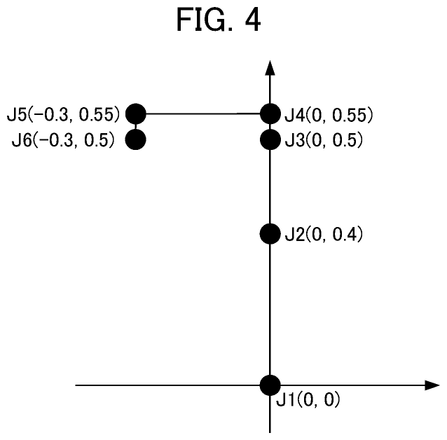

At the time of generating a joint angle estimation model 252 described later, which is configured as a trained model, the input data acquisition unit 216 may convert the two-dimensional coordinates (pixel coordinates) (xᵢ, yᵢ) of the positions of the centers of the joint axes J1 to J6 included in the two-dimensional posture generated by the projection unit 215 to values of XY coordinates that have been normalized to satisfy −1<X<1 by being divided by the width of the frame image and satisfy −1<Y<1 by being divided by the height of the frame image, with the joint axis J1, which is a base link of the robot 10, as the origin, as shown in FIG. 4.

### <Label Acquisition Unit 217>

The label acquisition unit 217 acquires angles of the joint axes J1 to J6 of the robot 10 at the time when frame images were captured with the above-stated predetermined period that enables synchronization, such as 100 milliseconds, and two-dimensional postures indicating positions of the centers of the joint axes J1 to J6 of the robot 10 in the frame images, as label data (correct answer data).

Specifically, for example, the label acquisition unit 217 acquires the two-dimensional postures indicating the positions of the centers of the joint axes J1 to J6 of the robot 10, and the angles of the joint axes J1 to J6, from the projection unit 215 and the joint angle acquisition unit 213, as the label data (the correct answer data). The label acquisition unit 217 stores the acquired label data into the label data 242 of the storage unit 24.

### <Machine Learning Device 30>

The machine learning device 30 acquires, for example, the above-described frame images of the robot 10 captured by the camera 22, and distances and tilts between the camera 22 that has captured the frame images and the robot 10, which are stored in the input data 241, from the terminal device 20 as input data.

Further, the machine learning device 30 acquires angles of the joint axes J1 to J6 of the robot 10 at the time when the frame images were captured by the camera 22, and two-dimensional postures indicating positions of the centers of the joint axes J1 to J6, which are stored in the label data 242, from the terminal device 20 as labels (correct answers).

The machine learning device 30 performs supervised learning with training data of pairs configured with the acquired input data and labels to construct a trained model described later.

By doing so, the machine learning device 30 can provide the constructed trained model for the terminal device 20.

The machine learning device 30 will be specifically described.

The machine learning device 30 includes a learning unit 301 and a storage unit 302 as shown in FIG. 1.

As described above, the learning unit 301 accepts the pairs of input data and label, from the terminal device 20 as training data. When the terminal device 20 is operating as a robot joint angle estimation device as described later, the learning unit 301 constructs, by performing supervised learning using the accepted training data, a trained model that receives input of a frame image of the robot 10 captured by the camera 22, and the distance and tilt between the camera 22 and the robot 10, and outputs angles of joint axes J1 to J6 of the robot 10 and a two-dimensional posture indicating positions of the centers of the joint axes J1 to J6.

In the present invention, the trained model is constructed to be configured with a two-dimensional skeleton estimation model 251 and the joint angle estimation model 252.

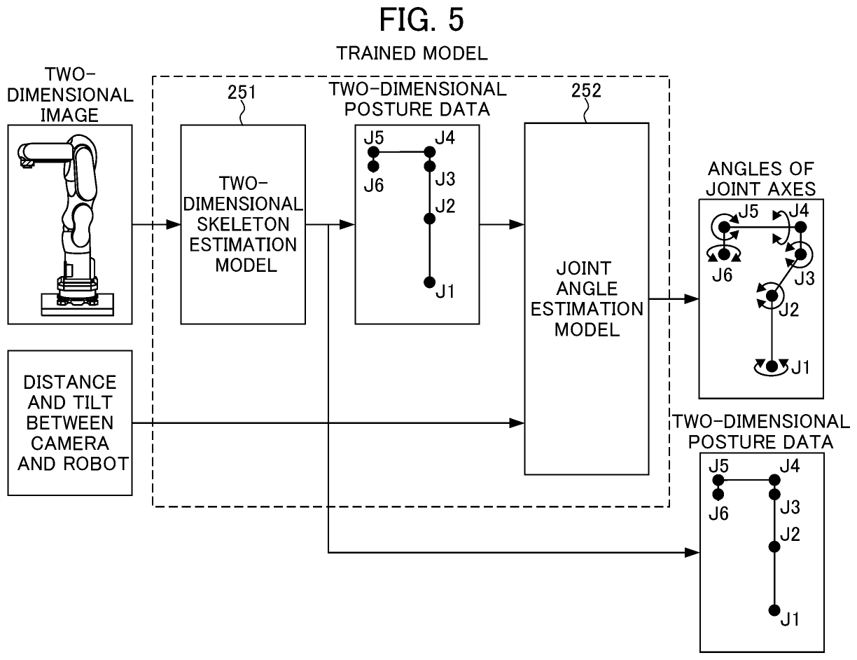

FIG. 5 Is a diagram showing an example of a relationship between the two-dimensional skeleton estimation model 251 and the joint angle estimation model 252.

As shown in FIG. 5, the two-dimensional skeleton estimation model 251 is a model that receives input of a frame image of the robot 10 and outputs a two-dimensional posture of pixel coordinates indicating positions of the centers of the joint axes J1 to J6 of the robot 10 in the frame image. The joint angle estimation model 252 is a model that receives input of the two-dimensional posture outputted from the two-dimensional skeleton estimation model 251, and the distance and tilt between the camera 22 and the robot 10, and outputs angles of the joint axes J1 to J6 of the robot 10.

The learning unit 301 provides the trained model including the constructed two-dimensional skeleton estimation model 251 and joint angle estimation model 252, for the terminal device 20.

Description will be made below on construction of each of the two-dimensional skeleton estimation model 251 and the joint angle estimation model 252.

### <Two-Dimensional Skeleton Estimation Model 251>

For example, based on a deep learning model used for a well-known markerless animal tracking tool (for example, DeepLabCut) or the like, the learning unit 301 performs machine learning based on training data configured with input data of frame images of the robot 10 and labels of two-dimensional postures indicating positions of the centers of the joint axes J1 to J6 at the time when the frame images were captured, the training data having been accepted from the terminal device 20, and generates the two-dimensional skeleton estimation model 251 that receives input of a frame image of the robot 10 captured by the camera 22 of the terminal device 20, and outputs a two-dimensional posture of pixel coordinates indicating positions of the centers of the joint axes Jl to J6 of the robot 10 in the captured frame image.

Specifically, the two-dimensional skeleton estimation model 251 is constructed based on a CNN (convolutional neural network) which is a neural network.

The convolutional neural network has a structure provided with a convolutional layer, a pooling layer, a fully connected layer, and an output layer.

In the convolutional layer, a predetermined parameter filter is applied to an inputted frame image in order to perform feature extraction such as edge extraction. The predetermined parameter of the filter corresponds to the weight of the neural network, and is learned by repeating forward propagation and back propagation.

In the pooling layer, the image outputted from the convolutional layer is blurred in order to allow position misalignment of the robot 10. Thereby, even if the position of the robot 10 fluctuates, the robot 10 can be regarded as the identical object.

By combining these convolutional layer and pooling layer, feature values can be extracted from the frame image.

In the fully connected layer, pieces of image data of feature parts that have been taken out through the convolutional layer and the pooling layer are combined to be one node, and a feature map of values converted by an activation function, that is, a feature map of confidence degrees is outputted.

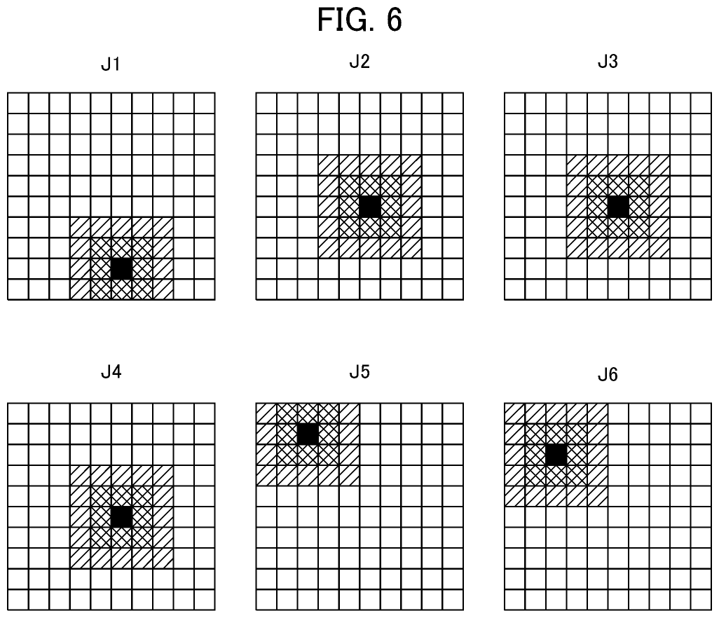

FIG. 6 is a diagram showing an example of feature maps of the joint axes J1 to J6 of the robot 10.

As shown in FIG. 6, in each of the feature maps of the joint axes J1 to J6, the value of the confidence degree cᵢ is indicated within a range of 0 to 1. For a cell closer to the position of the center of a joint axis, a value closer to “1” is obtained. For a cell farther away from the position of the center of a joint axis, a value closer to “0” is obtained.

In the output layer, the row, column, and confidence degree (maximum) of a cell at which the confidence degree is the maximum value, in each of the feature maps of the joint axes J1 to J6, which are the output from the fully connected layer, is outputted. In a case where the frame image is convoluted to become 1/N in the convolutional layer, the row and column of each cell is increased by N times in the output layer, and pixel coordinates indicating the position of the center of each of the joint axes J1 to J6 in the frame image are set (N is an integer equal to or larger than 1).

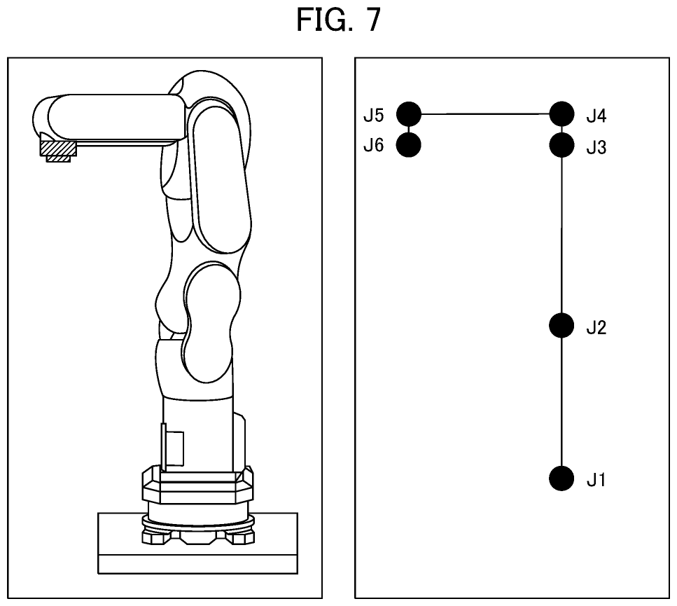

FIG. 7 is a diagram showing an example of comparison between a frame image and an output result of the two-dimensional skeleton estimation model 251.

### <Joint Angle Estimation Model 252>

The learning unit 301 performs machine learning, for example, based on training data configured with input data including distances and tilts between the camera 22 and the robot 10, and two-dimensional postures indicating the above-stated normalized positions of the centers of the joint axes J1 to J6, and label data of angles of the joint axes J1 to J6 of the robot 10 at the time when frame images were captured, to generate the joint angle estimation model 252.

Though the learning unit 301 normalizes the two-dimensional posture of the joint axes J1 to J6 outputted from the two-dimensional skeleton estimation model 251, the two-dimensional skeleton estimation model 251 may be generated such that a normalized two-dimensional posture is outputted from the two-dimensional skeleton estimation model 251.

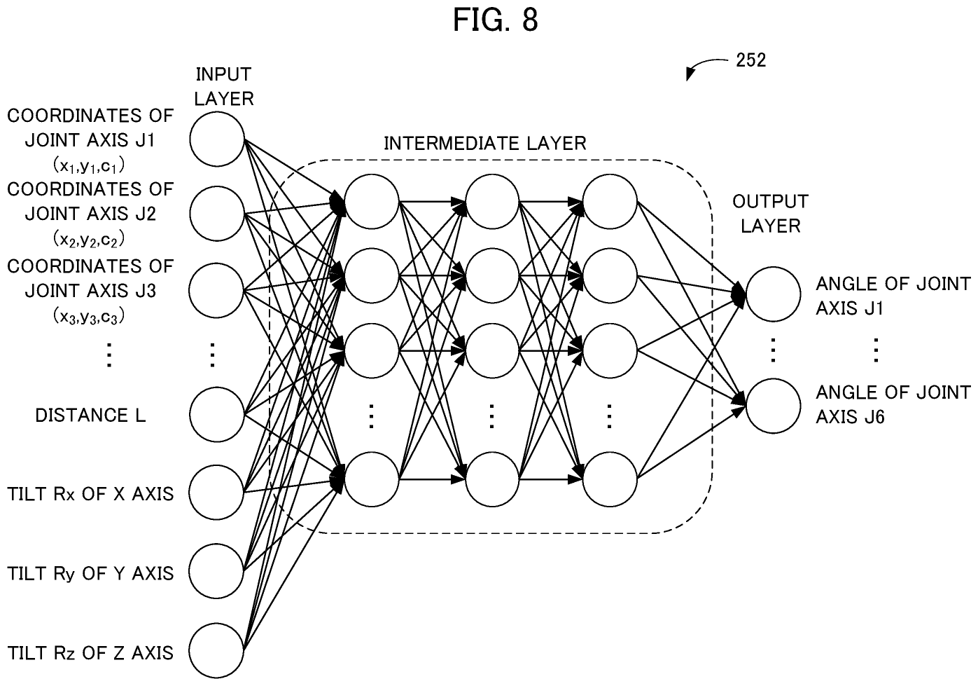

FIG. 8 is a diagram showing an example of the joint angle estimation model 252. Here, as the joint angle estimation model 252, a multilayer neural network is exemplified in which a two-dimensional posture indicating positions of the centers the joint axes J1 to J6 outputted from the two-dimensional skeleton estimation model 251 and normalized, and the distance and tilt between the camera 22 and the robot 10 are the input layer, and angles of the joint axes J1 to J6 are the output layer, as shown in FIG. 8. The two-dimensional posture is indicated by (xᵢ, y_{y}, cᵢ) including the coordinates (xᵢ, y_{y}), which indicate normalized positions of the centers of the joint axes J1 to J6, and confidence degrees cᵢ.

Further, “inclination Rx of X axis”, “inclination Ry of Y axis”, and “inclination Rz of Z axis” are a rotation angle around the X axis, a rotation angle around the Y axis, and a rotation angle around the Z axis, between the camera 22 and the robot 10 in the world coordinate system that are calculated based on three-dimensional coordinate values of the camera 22 in the world coordinate system and three-dimensional coordinate values of the robot origin of the robot 10 in the world coordinate system.

The learning unit 301 may be adapted to, if acquiring new training data after constructing a trained model configured with the two-dimensional skeleton estimation model 251 and the joint angle estimation model 252, update a trained model configured with the two-dimensional skeleton estimation model 251 and the joint angle estimation model 252, which has been once constructed, by further performing supervised learning for the trained model configured with the two-dimensional skeleton estimation model 251 and the joint angle estimation model 252.

By doing so, training data can be automatically obtained from regular photographing of the robot 10, and, therefore, the accuracy of estimating the two-dimensional posture and angles of the joint axes J1 to J6 of the robot 10 can be increased on the daily basis.

The supervised learning described above may be performed as online learning, batch learning, or mini-batch learning.

The online learning is a learning method in which, each time a frame image of the robot 10 is captured, and training data is created, supervised learning is immediately performed. The batch learning is a learning method in which, while capturing of a frame image of the robot 10 and creation of training data are repeated, a plurality of pieces of training data corresponding to the repetition are collected, and supervised learning is performed using all the collected pieces of training data. The mini-batch learning is an intermediate learning method between the online learning and the batch learning, in which supervised learning is performed each time some pieces of training data have been collected.

The storage unit 302 is a RAM (random access memory) or the like, and stores input data and label data acquired from the terminal device 20, the two-dimensional skeleton estimation model 251 and the joint angle estimation model 252 constructed by the learning unit 301, and the like.

Description has been made above on machine learning for generating the two-dimensional skeleton estimation model 251 and the joint angle estimation model 252 provided in the terminal device 20 when the terminal device 20 operates as the robot joint angle estimation device.

Next, the terminal device 20 that operates as the robot joint angle estimation device on the operational phase will be described.

### <System on Operational Phase>

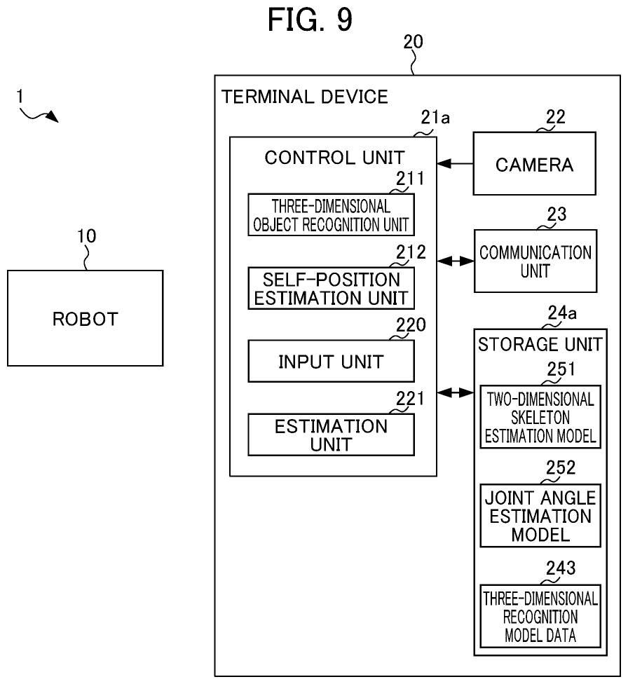

FIG. 9 is a functional block diagram showing a functional configuration example of a system according to one embodiment on the operational phase. As shown in FIG. 9, a system 1 includes a robot 10, and a terminal device 20 as the robot joint angle estimation device. As for components having functions similar to those of components of the system 1 of FIG. 1, the same reference numerals will be given, and detailed description of the components will be omitted.

As shown in FIG. 9, the terminal device 20 operating as the robot joint angle estimation device on the operational phase includes a control unit 21a, a camera 22, a communication unit 23, and a storage unit 24a. The control unit 21a includes a three-dimensional object recognition unit 211, a self-position estimation unit 212, an input unit 220, and an estimation unit 221.

The camera 22 and the communication unit 23 are similar to the camera 22 and the communication unit 23 on the learning phase.

The storage unit 24a is, for example, a ROM (read-only memory), an HDD (hard disk drive), or the like and stores a system program, a robot joint angle estimation application program, and the like executed by the control unit 21a described later. Further, the storage unit 24a may store the two-dimensional skeleton estimation model 251 and the joint angle estimation model 252 as a trained model, which have been provided from the machine learning device 30 on the learning phase, and the three-dimensional recognition model data 243.

<Control Unit 21a>

The control unit 21a includes a CPU (central processing unit), a ROM, a RAM, a CMOS (complementary metal-oxide-semiconductor) memory and the like, and these are configured being mutually communicable via a bus and are well-known to one skilled in the art.

The CPU is a processor that performs overall control of the terminal device 20. The CPU reads out the system program and the robot joint angle estimation application program stored in the ROM via the bus, and controls the whole terminal device 20 as the robot joint angle estimation device according to the system program and the robot joint angle estimation application program. Thereby, as shown in FIG. 9, the control unit 21a is configured to realize the functions of the three-dimensional object recognition unit 211, the self-position estimation unit 212, the input unit 220, and the estimation unit 221.

The three-dimensional object recognition unit 211 and the self-position estimation unit 212 are similar to the three-dimensional object recognition unit 211 and the self-position estimation unit 212 on the learning phase.

### <Input Unit 220>

The input unit 220 inputs a frame image of the robot 10 captured by the camera 22, and a distance L, the tilt Rx of the X axis, the tilt Ry of the Y axis, and the tilt Rz of the Z axis between the camera 22 and the robot 10 calculated by the self-position estimation unit 212.

### <Estimation Unit 221>

The estimation unit 221 inputs the frame image of the robot 10, and the distance L, the tilt Rx of the X axis, the tilt Ry of the Y axis, and the tilt Rz of the Z axis between the camera 22 and the robot 10, which have been inputted by the input unit 220, to the two-dimensional skeleton estimation model 251 and the joint angle estimation model 252 as a trained model. By doing so, the estimation unit 221 can estimate angles of the joint axes J1 to J6 of the robot 10 at the time when the inputted frame image was captured, and a two-dimensional posture indicating positions of the centers of the joint axes J1 to J6, from outputs of the two-dimensional skeleton estimation model 251 and the joint angle estimation model 252.

As described above, the estimation unit 221 normalizes pixel coordinates of positions of the centers of the joint axes J1 to J6 outputted from the two-dimensional skeleton estimation model 251 and inputs the pixel coordinates to the joint angle estimation model 252. Further, the estimation unit 221 may be adapted to set each confidence degree cᵢ of a two-dimensional posture outputted from the two-dimensional skeleton estimation model 251 to “1” when the confidence degree cᵢ is 0.5 or above and to “0” when the confidence degree cᵢ is below 0.5.

The terminal device 20 may be adapted to display the angles of the joint axes J1 to J6 of the robot 10, and the two-dimensional posture indicating the positions of the centers of the joint axes J1 to J6, which have been estimated, on a display unit (not shown), such as a liquid crystal display, included in the terminal device 20.

### <Estimation Process of Terminal Device 20 on Operational Phase>

Next, an operation related to an estimation process of the terminal device 20 according to the present embodiment will be described.

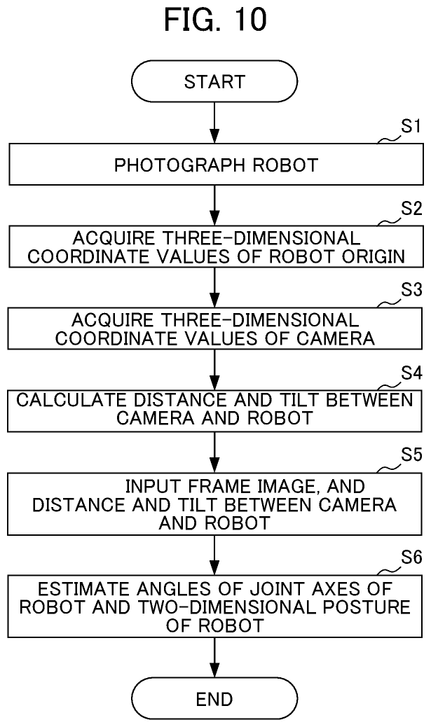

FIG. 10 is a flowchart illustrating the estimation process of the terminal device 20 on the operational phase. The flow shown here is repeatedly executed each time a frame image of the robot 10 is inputted.

At Step S1, the camera 22 photographs the robot 10 based on a worker's instruction via an input device, such as a touch panel (not shown), included in the terminal device 20.

At Step S2, the three-dimensional object recognition unit 211 acquires three-dimensional coordinate values of the robot origin in the world coordinate system, and information indicating a direction of each of the X, Y, and Z axes of the robot coordinate system, based on a frame image of the robot 10 captured at Step S1 and the three-dimensional recognition model data 243.

At Step S3, the self-position estimation unit 212 acquires three-dimensional coordinate values of the camera 22 in the world coordinate system, based on the frame image of the robot 10 captured at Step S1.

At Step S4, the self-position estimation unit 212 calculates the distance L, the tilt Rx of the X axis, the tilt Ry of the Y axis, and the tilt Rz of the Z axis between the camera 22 and the robot 10, based on the three-dimensional coordinate values of the camera 22 acquired at Step S3 and the three-dimensional coordinate values of the robot origin of the robot 10 acquired at Step S2.

At Step S5, the input unit 220 inputs the frame image captured at Step S1, and the distance L, the tilt Rx of the X axis, the tilt Ry of the Y axis, and the tilt Rz of the Z axis between the camera 22 and the robot 10 calculated at Step S3.

At Step S6, by inputting the frame image, and the distance L, the tilt Rx of the X axis, the tilt Ry of the Y axis, and the tilt Rz of the Z axis between the camera 22 and the robot 10, which have been inputted at Step S5, to the two-dimensional skeleton estimation model 251 and the joint angle estimation model 252 as a trained model, the estimation unit 221 estimates angles of the joint axes J1 to J6 of the robot 10 at the time when the inputted frame image was captured, and a two-dimensional posture indicating positions of the centers of the joint axes J1 to J6.

According to the above, by inputting a frame image of the robot 10, and the distance and tilt between the camera 22 and the robot 10 to the two-dimensional skeleton estimation model 251 and the joint angle estimation model 252 as a trained model, the terminal device 20 according to the one embodiment can easily acquire, even for a robot 10 that is not implemented with a log function or a dedicated I/F, angles of the joint axes J1 to J6 of the robot 10.

One embodiment has been described above. The terminal device 20 and the machine learning device 30, however, are not limited to the above embodiment, and modifications, improvements and the like within a range that the object can be achieved are included.

### Modification Example 1

Though the machine learning device 30 is exemplified as an device different from the robot control device (not shown) for the robot 10 and the terminal device 20 in the above embodiment, the robot control device (not shown) or the terminal device 20 may be provided with a part or all of the functions of the machine learning device 30.

### Modification Example 2

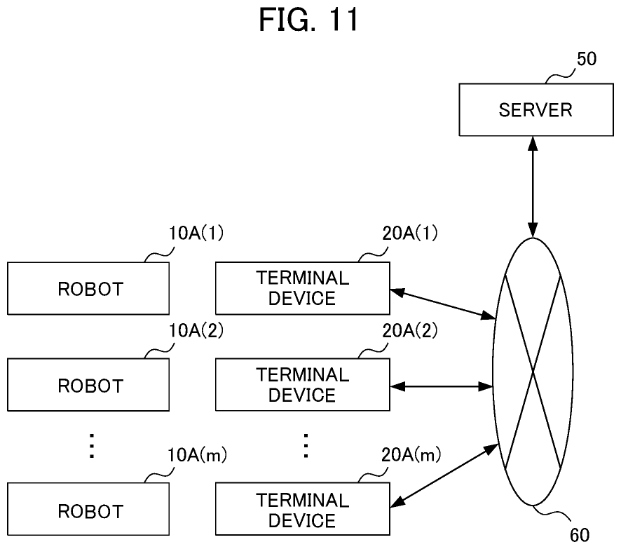

Further, for example, in the above embodiment, the terminal device 20 operating as the robot joint angle estimation device estimates angles of the joint axes J1 to J6 of the robot 10 and a two-dimensional posture indicating positions of the centers of the joint axes J1 to J6, from a frame image of the robot 10, and the distance and tilt between the camera 22 and the robot 10, which have been inputted, using the two-dimensional skeleton estimation model 251 and the joint angle estimation model 252 as a trained model, which has been provided from the machine learning device 30. However, the present invention is not limited thereto. For example, as shown in FIG. 11, a server 50 may store the two-dimensional skeleton estimation model 251 and joint angle estimation model 252 generated by the machine learning device 30, and share the two-dimensional skeleton estimation model 251 and the joint angle estimation model 252 with terminal devices 20A(1) to 20A(m) operating as m robot joint angle estimation devices, which are connected to the server 50 via a network 60 (m is an integer equal to or larger than 2). Thereby, even when a new robot and a new terminal device are arranged, the two-dimensional skeleton estimation model 251 and the joint angle estimation model 252 can be applied.

Each of robots 10A(1) to 10A(m) corresponds to the robot 10 of FIG. 9. Each of the terminal devices 20A(1) to 20A(m) corresponds to the terminal device 20 of FIG. 9.

Each function included in the terminal device 20 and the machine learning device 30 in the one embodiment can be realized by hardware, software, or a combination thereof. Here, being realized by software means being realized by a computer reading and executing a program.

Each component included in the terminal device 20 and the machine learning device 30 can be realized by hardware including an electronic circuit and the like, software, or a combination thereof. In the case of being realized by software, a program configuring the software is installed into a computer. The program may be recorded in a removable medium and distributed to a user or may be distributed by being downloaded to the user's computer via a network. In the case of being configured with hardware, a part or all of functions of each component included in the above devices can be configured with an integrated circuit (IC), for example, an ASIC (application specific integrated circuit), a gate array, an FPGA (field programmable gate array), a CPLD (complex programmable logic device), or the like.

The program can be supplied to the computer by being stored in any of various types of non-transitory computer-readable media. The non-transitory computer-readable media include various types of tangible storage media. Examples of the non-transitory computer-readable media include a magnetic recording medium (for example, a flexible disk, a magnetic tape, or a hard disk drive), a magneto-optical recording medium (for example, a magneto-optical disk), a CD-ROM (read-only memory), a CD-R, a CD-R/W, a semiconductor memory (for example, a mask ROM and a PROM (programmable ROM)), an EPROM (Erasable PROM), a flash ROM, and a RAM). The program may be supplied to the computer by any of various types of transitory computer-readable media. Examples of the transitory computer-readable media include an electrical signal, an optical signal and an electromagnetic wave. The transitory computer-readable media can supply the program to the computer via a wired communication path such as an electrical wire and an optical fibers, or a wireless communication path.

Steps describing the program recorded in a recording medium include not only processes that are performed chronologically in that order but also processes that are not necessarily performed chronologically but are executed in parallel or individually.

In other words, the training data generation device, the machine learning device, and the robot joint angle estimation device of the present disclosure can take many different embodiments having the following configurations.
(1) A training data generation device of the present disclosure is a training data generation device for generating training data for generating a trained model, the trained model receiving input of a two-dimensional image of a robot 10 captured by a camera 22, and a distance and a tilt between the camera 22 and the robot 10, and estimating angles of a plurality of joint axes J1 to J6 included in the robot 10 at the time when the two-dimensional image was captured, and a two-dimensional posture indicating positions of centers of the plurality of joint axes J1 to J6 in the two-dimensional image, the training data generation device including: an input data acquisition unit 216 configured to acquire the two-dimensional image of the robot 10 captured by the camera, and the distance and tilt between the camera and the robot 10; and a label acquisition unit 217 configured to acquire the angles of the plurality of joint axes J1 to J6 at the time when the two-dimensional image was captured, and the two-dimensional posture as label data.

According to this training data generation device, it is possible to, even for a robot that is not implemented with a log function or a dedicated I/F, generate training data that is optimal to generate a trained model for easily acquiring angles of the joint axes of the robot.
(2) A machine learning device 30 of the present disclosure includes: a learning unit 301 configured to execute supervised learning based on training data generated by the training data generation device according to (1) to generate a trained model.

According to the machine learning device 30, it is possible to, even for a robot that is not implemented with a log function or a dedicated I/F, generate a trained model that is optimal to easily acquire angles of the joint axes of the robot.
(3) The machine learning device 30 according to (2) may include the training data generation device according to (1).

By doing so, the machine learning device 30 can easily acquire training data.
(4) A robot joint angle estimation device of the present disclosure includes: a trained model generated by the machine learning device 30 according to (2) or (3); an input unit 220 configured to input a two-dimensional image of a robot 10 captured by a camera 22, and a distance and a tilt between the camera 22 and the robot 10; and an estimation unit 221 configured to input the two-dimensional image, and the distance and tilt between the camera 22 and the robot 10, which have been inputted by the input unit 220, to the trained model, and estimate angles of a plurality of joint axes J1 to J6 included in the robot 10 at the time when the two-dimensional image was captured, and a two-dimensional posture indicating positions of centers of the plurality of joint axes J1 to J6 in the two-dimensional image.

According to this robot joint angle estimation device, it is possible to, even for a robot that is not implemented with a log function or a dedicated I/F, easily acquire the angles of the joint axes of the robot.
(5) In the robot joint angle estimation device according to (4), the trained model may include a two-dimensional skeleton estimation model 251 receiving input of the two-dimensional image and outputting the two-dimensional posture, and a joint angle estimation model 252 receiving input of the two-dimensional posture outputted from the two-dimensional skeleton estimation model 251, and the distance and tilt between the camera 22 and the robot 10, and outputting the angles of the plurality of joint axes J1 to J6.

By doing so, the robot joint angle estimation device can, even for a robot that is not implemented with a log function or a dedicated I/F, easily acquire angles of the joint axes of the robot.
(6) In the robot joint angle estimation device according to (4) or (5), the trained model may be provided in a server 50 that is connected to be accessible from the robot joint angle estimation device via a network 60.

By doing so, the robot joint angle estimation device can apply a trained model even when a new robot and a new robot joint angle estimation device are arranged.
(4) The robot joint angle estimation device according to any of (4) to (6) may include the machine learning device 30 according to (2) or (3).

By doing so, the robot joint angle estimation device has effects similar to those of (1) to (6).

### EXPLANATION OF REFERENCE NUMERALS

1 System
10 Robot
101 Joint angle response server
20 Terminal device
21, 21a Control unit
211 Three-dimensional object recognition unit
212 Self-position estimation unit
213 Joint angle acquisition unit
214 Forward kinematics calculation unit
215 Projection unit
216 Input data acquisition unit
217 Label acquisition unit
220 Input unit
221 Estimation unit
22 Camera
23 Communication unit
24, 24a Storage unit
241 Input data
242 Label data
243 Three-dimensional recognition model data
251 Two-dimensional skeleton estimation model
252 Joint angle estimation model
30 Machine learning device
301 Learning unit
302 Storage unit

1. A training data generation device for generating training data for generating a trained model, the trained model receiving input of a two-dimensional image of a robot captured by a camera, and a distance and a tilt between the camera and the robot, and estimating angles of a plurality of joint axes included in the robot at a time when the two-dimensional image was captured, and a two-dimensional posture indicating positions of centers of the plurality of joint axes in the two-dimensional image, the training data generation device comprising:
an input data acquisition unit configured to acquire the two-dimensional image of the robot captured by the camera, and the distance and tilt between the camera and the robot; and
a label acquisition unit configured to acquire the angles of the plurality of joint axes at the time when the two-dimensional image was captured, and the two-dimensional posture as label data.

2. A machine learning device comprising a learning unit configured to execute supervised learning based on training data generated by the training data generation device according to claim 1 to generate a trained model.

3. The machine learning device according to claim 2, comprising a training data generation device,
the training data generation device being for generating training data for generating a trained model, the trained model receiving input of a two-dimensional image of a robot captured by a camera, and a distance and a tilt between the camera and the robot, and estimating angles of a plurality of joint axes included in the robot at a time when the two-dimensional image was captured, and a two-dimensional posture indicating positions of centers of the plurality of Joint axes in the two-dimensional image, the training data generation device comprising:
an input data acquisition unit configured to acquire the two-dimensional image of the robot captured by the camera, and the distance and tilt between the camera and the robot; and
a label acquisition unit configured to acquire the angles of the plurality of Joint axes at the time when the two-dimensional image was captured, and the two-dimensional posture as label data.

4. A robot joint angle estimation device comprising:
a trained model generated by the machine learning device according to claim 2;
an input unit configured to input a two-dimensional image of a robot captured by a camera, and a distance and a tilt between the camera and the robot; and
an estimation unit configured to input the two-dimensional image, and the distance and tilt between the camera and the robot, which have been inputted by the input unit, to the trained model, and estimate angles of a plurality of joint axes included in the robot at the time when the two-dimensional image was captured, and a two-dimensional posture indicating positions of centers of the plurality of joint axes in the two-dimensional image.

5. The robot joint angle estimation device according to claim 4, wherein the trained model includes a two-dimensional skeleton estimation model receiving input of the two-dimensional image and outputting the two-dimensional posture, and a joint angle estimation model receiving input of the two-dimensional posture outputted from the two-dimensional skeleton estimation model, and the distance and tilt between the camera and the robot, and outputting the angles of the plurality of joint axes.

6. The robot joint angle estimation device according to claim 4, wherein the trained model is provided in a server that is connected to be accessible from the robot joint angle estimation device via a network.

7. The robot joint angle estimation device according to claim 4, comprising a machine learning device, the machine learning device including a learning unit configured to execute supervised learning based on training data generated by a training data generation device to generate a trained model,
the training data generation device being for generating training data for generating a trained model, the trained model receiving input of a two-dimensional image of a robot captured by a camera, and a distance and a tilt between the camera and the robot, and estimating angles of a plurality of joint axes included in the robot at a time when the two-dimensional image was captured, and a two-dimensional posture indicating positions of centers of the plurality of Joint axes in the two-dimensional image, the training data generation device comprising:
an input data acquisition unit configured to acquire the two-dimensional image of the robot captured by the camera, and the distance and tilt between the camera and the robot; and
a label acquisition unit configured to acquire the angles of the plurality of Joint axes at the time when the two-dimensional image was captured, and the two-dimensional posture as label data.
